(19) United States
(12) Patent Application Publication
(10) Pub. No.: US 2003/0099028 A1
(43) Pub. Date: May 29, 2003

(54) Micro-mechanical device having anti-stiction layer and method of manufacturing the device

(75) Inventors: Chang-ho Cho, Suwon-city (KR); Hyung-jae Shin, Seongnam-city (KR); Woon-bae Kim, Suwon-city (KR)

Correspondence Address: SUGHRUE MION, PLLC, 2100 PENNSYLVANIA AVENUE, N.W., WASHINGTON, DC, 20037, US

(73) Assignee: Samsung Electronics Co., Ltd.

(21) Appl. No.: 10/151,011

(22) Filed: May 21, 2002

(30) Foreign Application Priority Data
Nov. 26, 2001 (KR) 2001-73733

(51) Int. Cl. G02F 1/29; G02B 26/08

(52) U.S. Cl. 359/298

(57) ABSTRACT

The micro-mechanical structure includes an anti-stiction layer formed by plasma enhanced chemical vapor deposition. The anti-stiction layer is formed on only the area of a substrate other than the top of a movable structure and a part of an electrode that is subsequently bonded to a wire.

### BACKGROUND OF THE INVENTION

This application is based on Korean Patent Application No. 2001-73733 filed on Nov. 26, 2001, the disclosure of which is incorporated herein by reference in its entirety.

1. Field of the Invention

The present invention relates in general to a micro-mechanical device, and more particularly to a micro-mechanical device having an anti-stiction layer and a method of manufacturing the device.

2. Description of the Related Art

Recently, many different types of micro-mechanical devices such as micro-motors, micro-gears, and micro-mirror devices have been developed. In micro-mirror devices, according to resolution, for example, 500,000 through 1,200,000 actuating micro aluminum mirrors having a size of 13-16 microns are disposed at intervals of 1 micron. Each of the mirrors, which is supported by a hinge, turns to the left or right at an angular width of ±10° in response to a signal generated from a digital board to form an image.

FIG. 1 shows a micro-mirror device as a micro-mechanical device disclosed in U.S. Pat. No. 5,331,454, entitled “Low Reset Voltage Process for DMD” and issued to Texas Instruments Incorporated (Dallas, Tex.).

In FIG. 1, when a driving voltage is applied between an address electrode 10 and a mirror 12, an electrostatic attractive force builds between the address electrode 10 and the mirror 12. The attraction between the two causes the mirror 12 to become inclined on a hinge 14, which is supported by a support layer 16. The hinge 14 twists and the edge of the inclined mirror 12 contacts or lands on a landing electrode 18 of a substrate 20. The mirror 12 may undesirably adhere to the surface of the landing electrode 18. The adhesion between the landing electrode 18 and the mirror 12 results in attractive inter-molecular forces between the two surfaces commonly referred to as Van der Waals forces. Van der Waals forces increase as the surface energy of a material increases, as the contact area between the surfaces increases, or as the contact time between the surfaces increases.

On technique to overcome the adhesion or stiction problem involves applying a voltage pulse train to the landing electrode 18. However, the amount of the applied voltage must be increased to depress an undesirable increase in the Van der Waals forces of the contacting surfaces. Finally, too much electrostatic attractive force builds between the mirror 12 and the landing electrode 18, such that the device may be damaged and possibly even causing the mirror 12 to snap off of its hinge 14.

In U.S. Pat. No. 5,331,454, powdered perfluordecanoic acid (PFDA) is deposited as a passivation material 34 on the landing electrode, as shown in FIG. 2. A method of vapor-depositing PFDA on the landing electrode 18 is disclosed in U.S. Pat. No. 5,602,671 in detail. Referring to FIG. 3, an oven 40 is preheated to 80° C. A source material 44, in this case PFDA, and a chip 46 are placed in a glass container 48. These are placed in the oven 40, which is evacuated by a valve 50 and backfilled through a valve 42 with dry N₂. When the PFDA reaches its melting temperature, it produces a vapor that is deposited onto the surface of the chip 46. The lid of the container 48 is removed after about 5 minutes of deposition, and the oven 40 is evacuated. Only a monolayer of PFDA is left on the chip 46. The PFDA monolayer produces beneficial effects, including a low surface energy, a low coefficient of friction, and a high wear resistance.

Although the conventional techniques discussed above are generally thought to be acceptable, they are not without shortcomings. In particular, a method of evaporating a solid source material and performing vapor deposition, as disclosed in U.S. Pat. Nos. 5,331,454 and 5,602,671, consumes valuable processing time to heat the source material, causes pollution, and requires surface activation.

Moreover, since a monolayer of PFDA having no cross link has volatility, hermetic sealing is necessary to maintain a constant sealing atmosphere within a device. This necessity results in an increase in the manufacturing cost and complex processes. In addition, the reliability of a monolayer decreases at high temperature. Since a monolayer is deposited to a thickness of several tens of angstroms through about 100 angstroms, it is impossible to adjust the thickness of the monolayer suitable to the size of a device, to improve characteristics and reliability, and to increase a life span.

### SUMMARY OF THE INVENTION

To solve the above-described problems, it is a first object of the present invention to provide a micro-mechanical device having an anti-stiction layer which reduces manufacturing time and prevents pollution, and a method of manufacturing the device.

It is a second object of the present invention to provide a micro-mechanical device having an anti-stiction layer that does not need a separate cleaning or activation process and can be applied regardless of the type of substrate, and a method of manufacturing the device.

It is a third object of the present invention to provide a micro-mechanical device having an anti-stiction layer which does not require hermetic sealing, and a method of manufacturing the device.

It is a fourth object of the present invention to provide a micro-mechanical device having an anti-stiction layer in which the thickness can be freely adjusted to suit the size of the device, to improve the characteristics and reliability of the device, and to increase the life span of the device, and a method of manufacturing the device

To achieve the above objects, in one aspect, the micro-mechanical structure includes a substrate, at least one movable structure formed on the substrate and contacting another surface, and a passivation layer which is formed on the entire surface of the substrate having the movable structure by a plasma enhanced chemical vapor deposition.

In another aspect, the micro-mechanical structure includes a substrate, at least one electrode formed on the substrate, at least one movable structure which is separated from the substrate by a predetermined distance and partially contacts the electrode, and a passivation layer which is formed on the area of the substrate other than a part of the top of the electrode and the top of the movable structure by a plasma enhanced chemical vapor deposition.

In still another aspect, a method of manufacturing the micro-mechanical structure includes the steps of preparing a substrate comprising an insulation unit having a predetermined circuit on its surface, forming at least one electrode patterned in a predetermined shape on the substrate, forming a sacrificial layer having a hole on the surfaces of the electrode and the substrate, forming a movable structure around the hole of the sacrificial layer, completing the movable structure contacting the electrode by removing the sacrificial layer, and forming a passivation layer on the substrate having the movable structure using plasma enhanced chemical vapor deposition.

### BRIEF DESCRIPTION OF THE DRAWINGS

The above objects and advantages of the present invention will become more apparent by describing in detail illustrative, non-limiting embodiments thereof with reference to the attached drawings in which:

FIGS. 1 and 2 are diagrams of conventional micro-mechanical devices;

FIG. 3 is a schematic diagram of plasma vapor deposition (PVD) equipment for manufacturing a conventional micro-mechanical device;

FIGS. 4A through 4I are diagrams of stages in the process of manufacturing a micro-mechanical device according to an embodiment of the present invention;

FIG. 5 is a schematic diagram of plasma enhanced chemical vapor deposition (PECVD) equipment applied to a micro-mechanical device according to the embodiment of the present invention;

FIG. 6 is a flowchart of a method of manufacturing a micro-mechanical device according to a first embodiment of the present invention; and

FIG. 7 is a flowchart of a method of manufacturing a micro-mechanical device according to a second embodiment of the present invention.

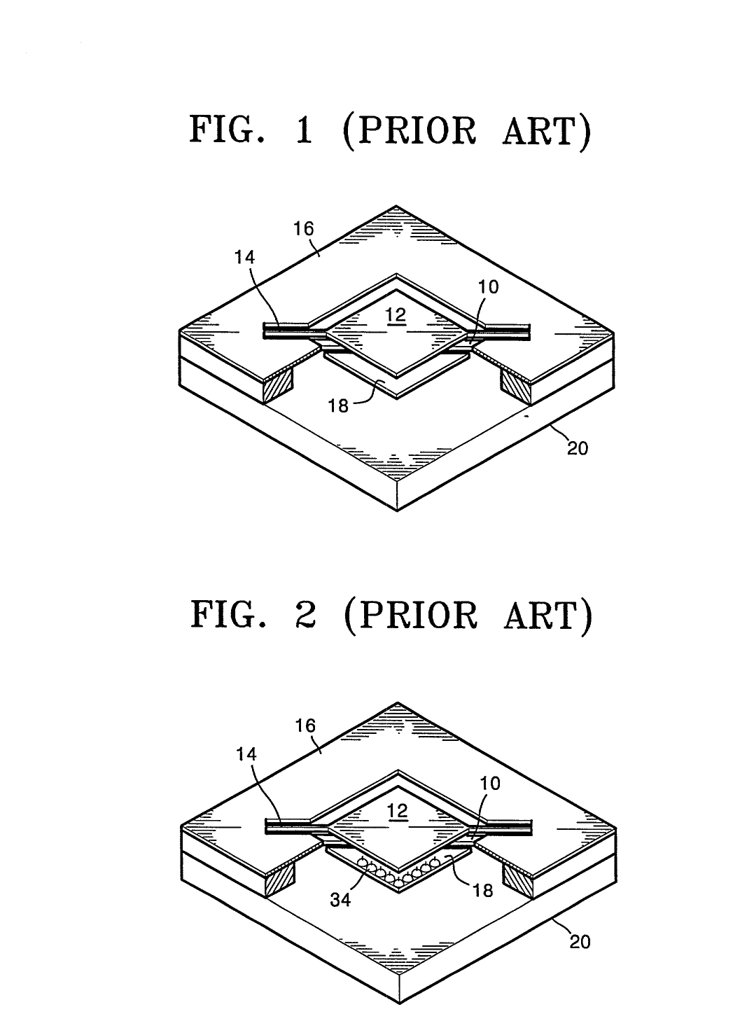

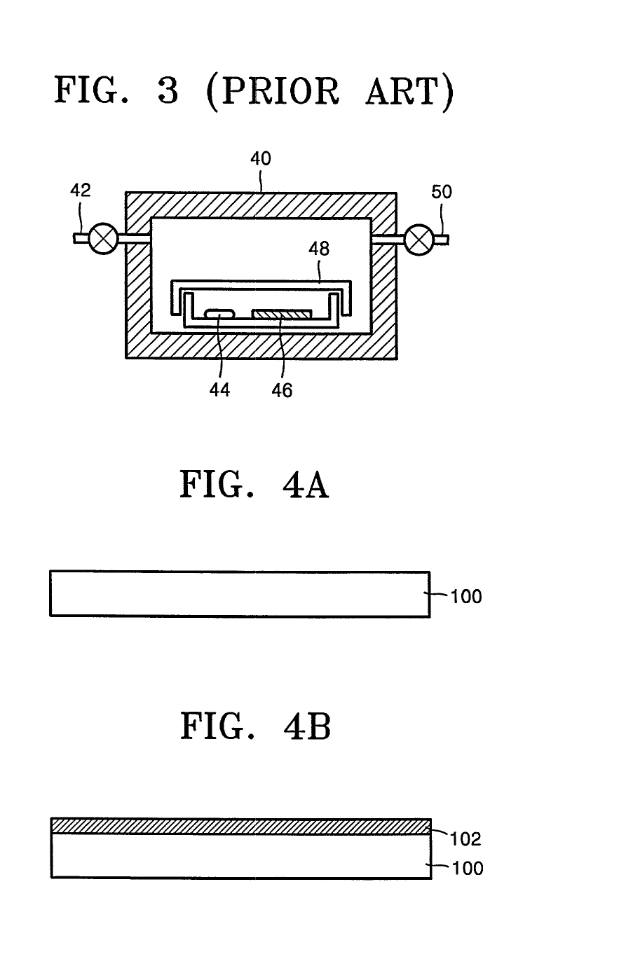

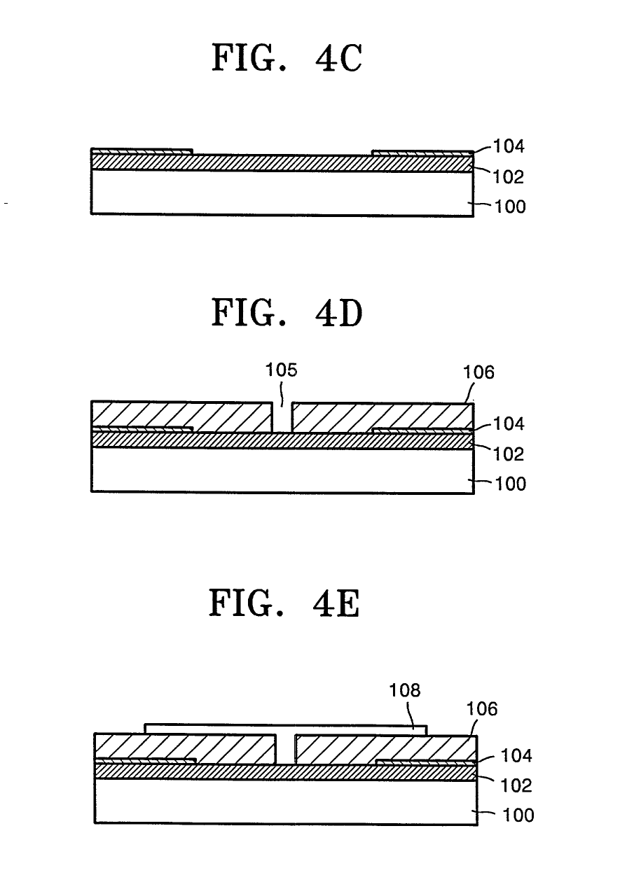

### DETAILED DESCRIPTION OF THE INVENTION

Illustrative, non-limiting embodiments of the present invention will be described in detail with reference to the attached drawings. The present invention is not restricted to the following embodiments, and many variations are possible within the spirit and scope of the present invention. The embodiments of the present invention are provided to more completely explain the present invention to anyone skilled in the art. The drawings are provided to explain the present invention. In the drawings, the same reference numerals denote the same members.

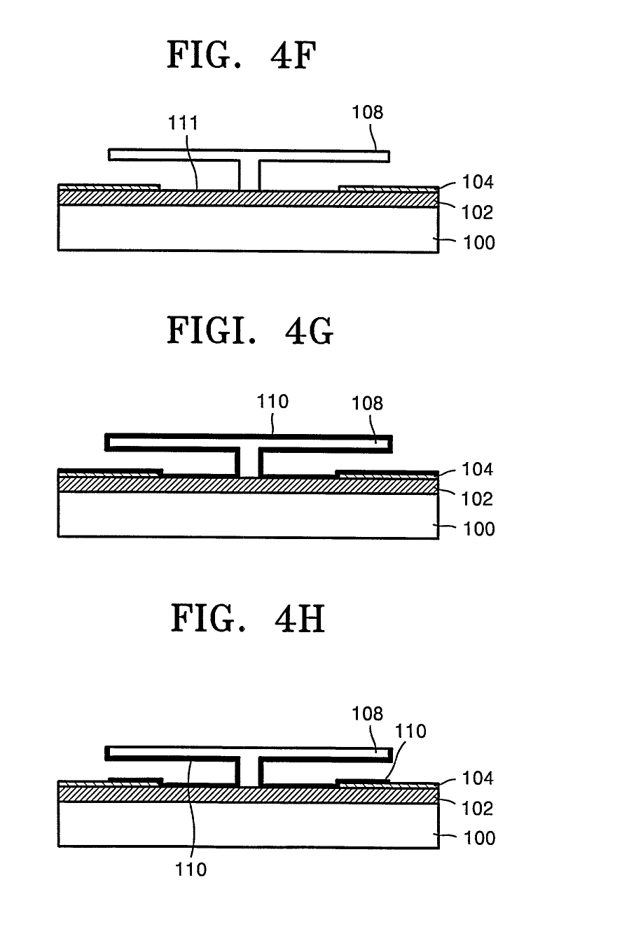

FIGS. 4A through 4I show stages in the process of manufacturing a micro-mechanical device according to an embodiment of the present invention.

As shown in FIG. 4A, a silicon substrate 100 of a thickness of, for example, about 500-800 μm is provided. As shown in FIG. 4B, an insulation unit 102 including a circuit is formed on the substrate 100. As shown in FIG. 4C, an electrode 104 for electrically connecting the circuit to a structure is formed. As shown in FIG. 4D, a sacrificial layer 106 having a hole 105 is formed to a thickness of about 1-2 μm on the entire surface of the electrode 104 and the entire surface of the exposed insulation unit 102. As shown in FIG. 4E, a movable structure 108 is formed on the sacrificial layer 106. The process shown in FIGS. 4A through FIG. 4E is referred to as wafer processing.

After the wafer processing, the sacrificial layer 106 is removed so that the movable structure 108 is separated from the substrate 100 and becomes movable, as shown in FIG. 4F.

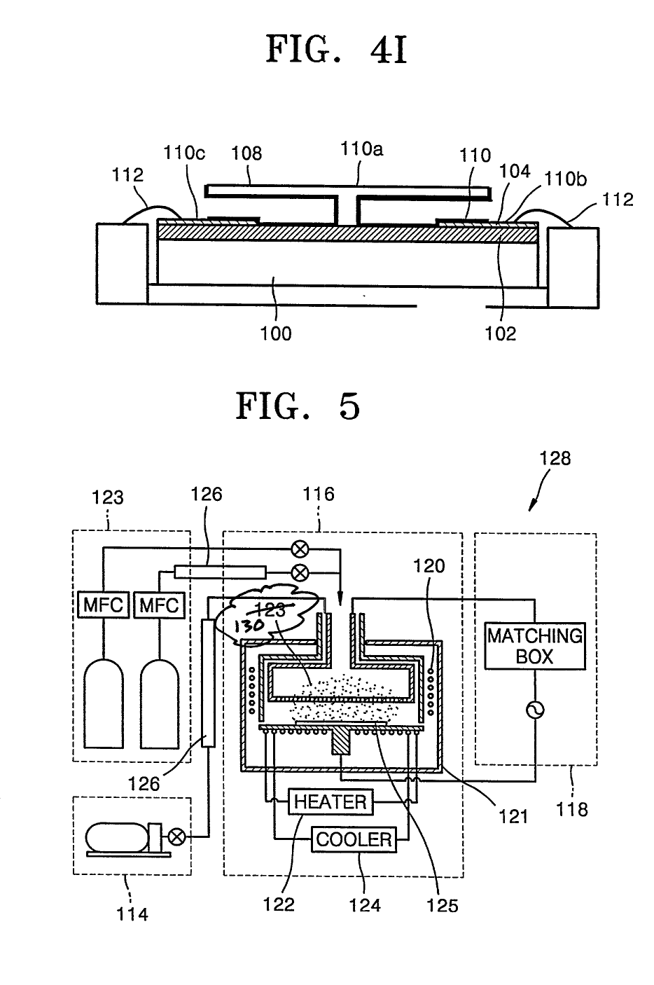

After removing the sacrificial layer 106, an anti-stiction layer 110 according to the present invention is formed to a thickness of about 100-1000 Å on the entire surfaces of the movable structure 108, the electrode 104, and the exposed insulation unit 102, as shown in FIG. 4G. The deposition of the anti-stiction layer 110 is performed by a capacitively couple radio frequency (CCRF) plasma reactor 128 as shown in FIG. 5. In addition, a method such as an inductively coupled plasma (ICP) method, or an electron cyclotron resonance (ECR) method using high-density plasma, or a method of forming a layer having predetermined characteristics by generating plasma as a pulse and adjusting the duty ratio of the pulse can be considered.

The CCRF plasma reactor 128 shown in FIG. 5 includes a source supply unit 123, a vacuum pump unit 114, a chamber unit 116, and an RF generator 118. Heaters 120 are provided on both side walls of a chamber 121, heaters 122 and coolers 124 are alternately provided in a lower portion of the chamber 121, and a line heater 126 is provided at a gas pipe, so that the temperature of a substrate 125 can be independently controlled.

Fluorocarbon (CₓF_{y}), hydrocarbon (CₓH_{y}), hydrofluorocarbon (CₓH_{y}F_{z}), or a mixture of these gases are representative deposition gases that can be used for generating plasma. Alternatively, plasma can be generated by adding an inert gas, such as Ar, He, or N₂, to the deposition gas.

In the present embodiment, octafluorocyclobutane (C₄F₈) and argon (Ar) are used. Argon is used to stabilize and surface-activate plasma 130. Octafluorocyclobutane in which a ratio of fluorine to carbon is 2 is used because it is easily decomposed, supplies a large amount of reactant, and results in less pollution. Deposition of the anti-stiction layer 110 of FIG. 4G may be substantially performed through three stages, i.e., cleaning, deposition, and heat treatment. A cleaning process is performed to minimize a change occurring in the thickness or characteristics of a deposited thin film according to a state of the surface of the thin film. Considering a die attaching process performed after a deposition process, a heat treatment process is performed in the atmosphere for 10 minutes at a temperature of 150° C.

The characteristics of the anti-stiction layer 110 vary with the deposition conditions such as process pressure, power, the partial pressure of C₄F₈, and substrate temperature. As a result of analyzing the influence of pressure, power, and partial pressure on plasma through tests performed changing the deposition conditions, it was concluded that the optimal conditions of deposition of the anti-stiction layer 110 were C₄F₈ at 8 sccm, Ar at 6 sccm, a pressure of 500 mTorr, a power of 25 Watts, and a substrate temperature of 50° C. A deposition rate was about 25 nm/min under the optimal conditions.

The anti-stiction layer 110, which is formed through the above processes, is necessary only for a portion of the movable structure 108. The anti-stiction layer 110 deposited on the reflecting surface (i.e., the upward facing surface in FIG. 4G) of the movable structure 108 impedes the reflection of light. For example, even in the case of a surface totally reflecting all incident light, if the anti-stiction layer 110 is deposited on the surface to a thickness of about 150 Å, a reflection loss of about 0.8% occurs. In addition, the anti-stiction layer 110 deposited on the surface of the electrode 104 increases contact resistance. Moreover, it is difficult to perform soldering on the anti-stiction layer 110 having low surface energy, so wire bonding is not accomplished smoothly.

Accordingly, it is not necessary to form the anti-stiction layer 110 on portions of the device other than a lower portion of the movable structure 108 and a portion that is located below the movable structure 108.

To this end, in the present invention, deposition and etching processes are alternately repeated in a plasma state. This repetitive process is referred to herein as a deposition-etched-deposition (DED) process. In general, plasma enhanced chemical vapor deposition (PECVD) performs deposition using a chemical reaction unlike plasma vapor deposition (PVD). Energetic particles (electrons or ions) directly activate a surface, and reactant is deposited on the surface, so deposition is less influenced by a state of the surface. However, when plasma is generated, there is a difference in mobility between ions and electrons within the plasma, provoking negative bias toward a substrate. As a result, many ion collisions occur on the top of the movable structure 108 shown in FIG. 4F and a portion of the device located laterally beyond the range of the movable structure 108, thereby accelerating the chemical reaction on these portions. Therefore, when a thin film is deposited using plasma, the thin film is thicker on the top of the movable structure 108 and the portion that is located laterally beyond the range of the movable structure 108 than on the lower portion of the movable structure 108 and the portion that is located below the movable structure 108. Accordingly, in the present invention, the thicker portion of the thin film is thinned using an etching process, which is part of the DED process.

By performing a DED process according to the illustrative, non-limiting embodiment of the present invention, the above-described problems can be overcome, and an unnecessary portion of an anti-stiction layer can be removed.

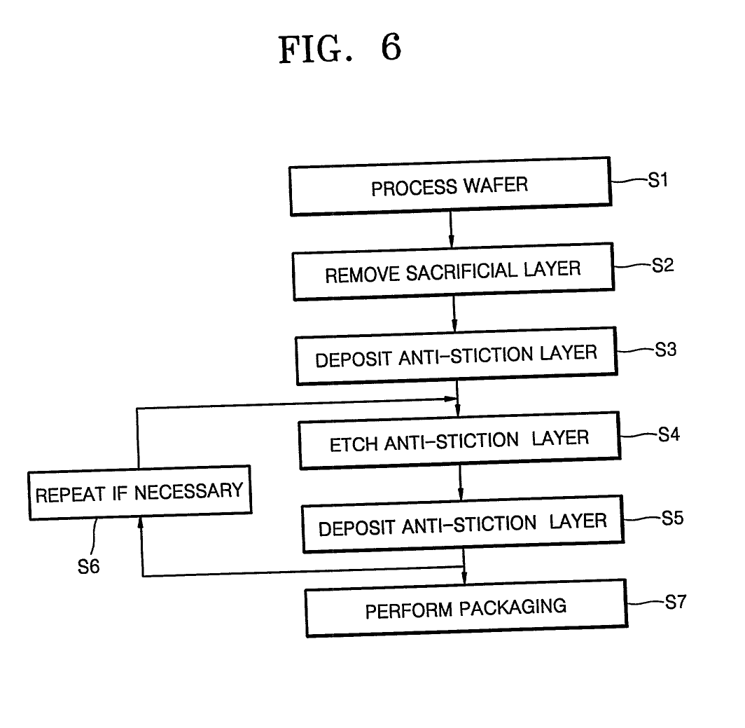

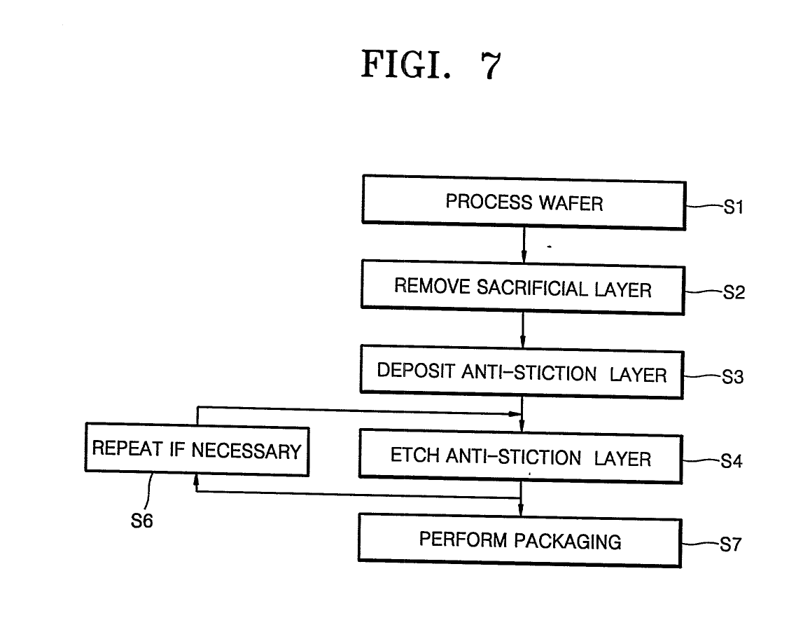

The DED process will be described with reference to the flowcharts shown in FIGS. 6 and 7. The DED process will also be appreciated by referring to FIGS. 4E through 41.

Turning to FIG. 6, the wafer processing described above is completed in step S1, as shown in FIG. 4E. The sacrificial layer is removed in step S2, as shown in FIG. 4F. Alternatively, before moving the sacrificial layer 106, dicing can be performed. After the sacrificial layer 106 is removed in step S2, a completed structure (referred to as the substrate 125 in FIG. 5) is placed in the plasma reactor 128 of FIG. 5 and maintained at predetermined temperature and pressure with a predetermined gas to excite plasma and deposit the anti-stiction layer 110 in step S3, as shown in FIG. 4G. An etching process is performed in the same plasma reactor 128 in step S4. The same deposition process as step S3 is performed in step S5. According to circumstances, the last deposition process S5 can be omitted, as shown in FIG. 7.

If necessary, as shown in FIGS. 6 and 7, deposition and etching processes are alternately repeated through step S6. After completion of the anti-stiction layer 110, the heat treatment described before is performed on the substrate. FIG. 4H shows the result structure formed through steps S1 through S6 in FIG. 6 or 7.

As shown in FIG. 4H, the anti-stiction layer 110 is provided primarily on the portions of the device needing it. This is because the anti-stiction layer 110 on the top of the movable structure 108 and on the portion of the substrate 125 located beyond the range of the movable structure 108 is etched. However, the remaining portions of the movable structure 108 (i.e., the portions other than the top or reflecting surface), which include a contact portion needing the anti-stiction layer 110, and the portion of the substrate 125 located below the movable structure 108 are not etched due to the influence of the movable structure 108.

In other words, as shown in FIG. 41 (which shows the result of completing a packaging process in step S7 of FIG. 6 or 7), the anti-stiction layer 110 may be etched so that it does not exist on (1) the electrode portions 110b and 110c that are subsequently bonded to wires 112 for electrical connections, and (2) a surface 110a of the movable structure 108, which is used as a reflector.

According to the present invention, reactant is deposited on the surface of a substrate while electrons or ions are directly activating the substrate surface in a plasma state, so the processes of cleaning and activating the substrate surface are not necessary. The present invention can be applied to any kind of substrate. For example, an anti-stiction layer according to the present invention can be deposited on any surface when a substrate is formed of silicon oxide and a movable structure is formed of aluminum or when the substrate is formed of silicon and metal.

In addition, since all processes are performed in vacuum equipment and byproducts are discharged into a vacuum during deposition, no residual substance is left, thereby realizing a clean process, unlike a conventional technique using a solid source that causes pollution. This feature of the present invention is particularly advantageous when it is applied to micro-mechanical structures, which are fatally vulnerable to particles.

Also, the present invention can be practiced using safe processes in terms of the human body and environment by using CₓF_{y} as a precursor for PECVD.

Moreover, in the case of PECVD, since all processes are performed within vacuum equipment and without consuming time for heating of a source and movement, manufacturing time can be remarkably reduced.

Since a small amount of source gas can be controlled using, for example, a mass flow controller, the present invention consumes a smaller amount of source gas than conventional PVD or deposition using solution immersion, thereby enabling a micro-mechanical device to be manufactured at 10% of the conventional manufacturing cost.

The present invention enables the thickness of an anti-stiction layer to be controlled at specific positions of the device by alternately performing etching and deposition, thereby decreasing the thickness of the anti-stiction layer as much as possible on a portion which does not positively need deposition of the anti-stiction layer and increasing the thickness of the anti-stiction layer on a portion, for example, a contact portion, needing the anti-stiction layer for increasing the reliability and life span of the device.

This invention has been particularly shown and described with reference to illustrative, non-limiting embodiments. It will be understood by those skilled in the art that various changes in form and details may be made without departing from the spirit and scope of the invention as defined by the appended claims.

What is claimed is:

1. A micro-mechanical structure comprising;
a substrate;
at least one movable structure formed on the substrate, the movable structure being movable to contact a portion of a surface of the substrate that faces toward the moveable structure; and
a passivation layer provided on the entire surface of the substrate that faces toward the moveable structure, the passivation layer formed by plasma enhanced chemical vapor deposition.

2. The micro-mechanical structure of claim 1, wherein the passivation layer is an anti-stiction layer formed of at least one selected from the group consisting of a fluorocarbon polymer, a hydrocarbon polymer, and a hydrofluorocarbon polymer.

3. A micro-mechanical structure comprising;
a substrate;
at least one electrode formed on the substrate;
at least one movable structure supported by the substrate, such that the movable structure is separated from the substrate by a predetermined distance and movable to contact the electrode; and
a passivation layer, which is formed by plasma enhanced chemical vapor deposition, provided on the area of the substrate other than (1) a part of the top of the electrode, and (2) the top of the movable structure.

4. The micro-mechanical structure of claim 3, wherein the passivation layer is an anti-stiction layer formed of at least one selected from the group consisting of a fluorocarbon polymer, a hydrocarbon polymer, and a hydrofluorocarbon polymer.

5. The micro-mechanical structure of claim 3, wherein the passivation layer is formed by one of (1) repetition of deposition followed by etching, and (2) repetition of deposition followed by etching followed by deposition, the deposition being the plasma enhanced chemical vapor deposition.

6. A method of manufacturing a micro-mechanical structure, comprising the steps of:
preparing a substrate having an insulation unit with a surface on which a predetermined circuit is provided;
forming at least one electrode patterned in a predetermined shape on the substrate;
forming a sacrificial layer having a hole on the surfaces of the electrode and the substrate;
forming a movable structure around the hole of the sacrificial layer;
completing the movable structure by removing the sacrificial layer; and
forming a passivation layer on the substrate having the movable structure using plasma enhanced chemical vapor deposition.

7. The method of claim 6, further comprising the step of removing the passivation layer from a part of the top of the electrode and from the top of the movable structure.

8. The method of claim 6, further comprising the step of packaging the substrate after forming the passivation layer.

9. The micro-mechanical structure of claim 6, wherein the passivation layer is an anti-stiction layer formed of at least one selected from the group consisting of a fluorocarbon polymer, a hydrocarbon polymer, and a hydrofluorocarbon polymer.

10. The micro-mechanical structure of claim 6, wherein the passivation layer is formed on the area of the substrate having the movable structure other than (1) a part of the top of the electrode, and (2) the top of the movable structure, and
wherein the passivation layer is formed by one of (1) repetition of deposition followed by etching, and (2) repetition of deposition followed by etching followed by deposition.
